(19) United States
(12) Patent Application Publication
(10) Pub. No.: US 2025/0015468 A1
(43) Pub. Date: Jan. 9, 2025

(54) SECONDARY BATTERY

(71) Applicant: MURATA MANUFACTURING CO., LTD., Kyoto (JP)

(72) Inventor: Takenori YOSHIKAWA, Kyoto (JP)

(21) Appl. No.: 18/888,416

(22) Filed: Sep. 18, 2024

Related U.S. Application Data
(63) Continuation of application No. PCT/JP2023/010114, filed on Mar. 15, 2023.

(30) Foreign Application Priority Data
Mar. 30, 2022 (JP) 2022-057360

(51) Int. Cl. H01M 50/595; H01M 50/105; H01M 50/186; H01M 50/531; H01M 50/586

(52) U.S. Cl. CPC H01M 50/595; H01M 50/105; H01M 50/186; H01M 50/531; H01M 50/586

(57) ABSTRACT

A secondary battery is provided and includes an electrode assembly in which a plurality of positive electrodes and negative electrodes are laminated with a separator interposed between them, a plurality of current collecting tabs extending from each current collector of a plurality of the positive electrodes and negative electrodes, a conductive terminal joined to a plurality of the current collecting tabs, and a laminate film including the electrode assembly. A plurality of the positive electrodes and negative electrodes have a current collector and an active material layer formed on a surface of the current collector. The secondary battery further includes an insulating tape covering a joint portion between a plurality of the current collecting tabs and the terminal. The laminate film has a sealing portion, and the tape has a first edge portion at one end on a tip side of the terminal and a second edge portion at another end, and each of the first edge portion and the second edge portion has a plurality of irregularities.

### CROSS REFERENCE TO RELATED APPLICATIONS

The present application is a continuation of PCT patent application no. PCT/JP2023/010114, filed on Mar. 15, 2023, which claims priority to Japanese patent application no. 2022-057360, filed on Mar. 30, 2022, the entire contents of which are incorporated herein by reference.

### BACKGROUND

The present application relates to a secondary battery.

A configuration is described in which an insulating tape is attached to a joint portion between an electrode lead extending from a laminated electrode of a battery module and an electrode tab extending from exterior of the laminated electrode.

### SUMMARY

The present application relates to a secondary battery.

When an insulating tape starts to peel off, it is difficult to prevent the peeling from spreading over the entire surface.

The present application, in an embodiment, relates to providing a secondary battery capable of preventing peeling of a tape from spreading over the entire surface.

A secondary battery according to an embodiment of the present application includes an electrode assembly in which a plurality of positive electrodes and negative electrodes are laminated with a separator interposed between them, a plurality of current collecting tabs extending from each current collector of a plurality of the positive electrodes and negative electrodes, a conductive terminal joined to a plurality of the current collecting tabs, and a laminate film including the electrode assembly. A plurality of the positive electrodes and negative electrodes have a current collector and an active material layer formed on a surface of the current collector. The secondary battery further includes an insulating tape covering a joint portion between a plurality of the current collecting tabs and the terminal. The laminate film has a sealing portion, and the tape has a first edge portion at one end on a tip side of the terminal and a second edge portion at another end, and each of the first edge portion and the second edge portion has a plurality of irregularities.

According to an embodiment of the present application, it is possible to prevent peeling of a tape from spreading over the entire surface.

### BRIEF DESCRIPTION OF THE FIGURES

FIG. 1 is a schematic diagram illustrating a main configuration of a secondary battery, particularly a configuration near a tape.

FIG. 2 is a schematic diagram illustrating a main configuration of an electrode assembly.

FIG. 3 is a sectional view taken along III-III of FIG. 2.

FIG. 4 is a schematic diagram illustrating a configuration near a welded portion before a tape is attached.

FIG. 5 is a schematic diagram illustrating an example of a secondary battery before being packaged in a laminate film.

FIG. 6 is a schematic diagram illustrating an example of a secondary battery after being packaged in a laminate film.

FIG. 7 is a schematic diagram of the tape illustrated in FIG. 5 as viewed from a plan viewpoint.

### DETAILED DESCRIPTION

The present application will be described in further detail including with reference to the drawings according to an embodiment. Note that the present application is not limited thereto. Each embodiment is illustrative, and replacement and combination of a part of configurations shown in different embodiments can be performed. In a second embodiment and subsequent embodiments, description of items common to a first embodiment will be omitted, and only different points will be described. In particular, a similar effect by a similar configuration will not be sequentially referred to for each embodiment.

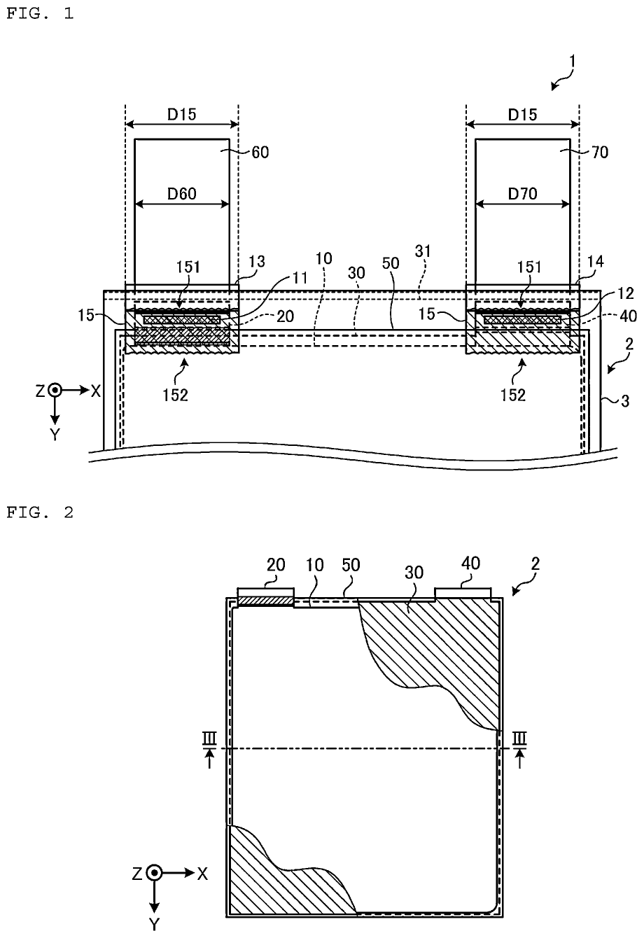

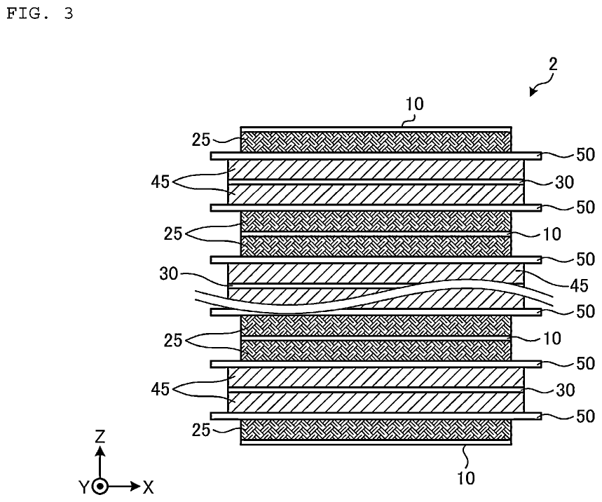

FIG. 1 is a schematic diagram illustrating a main configuration of a secondary battery 1, particularly a configuration near a tape 15. The secondary battery 1 includes a tape 15 attached to a welded portion 11 between a current collecting tab 20 extending from an electrode assembly 2 and a terminal 60 and a welded portion 12 between a current collecting tab 40 extending from the electrode assembly 2 and a terminal 70. Prior to description of the tape 15, the electrode assembly 2 included in the secondary battery 1 will be described with reference to FIGS. 2 and 3.

In FIG. 1, a direction in which the current collecting tabs 20 and 40 extend from the electrode assembly 2 is defined as a Y direction. Further, an arrangement direction of the current collecting tab 20 and the current collecting tab 40 is defined as an X direction. The X direction corresponds to a width direction orthogonal to both the Y direction and a Z direction which is a laminating direction of a positive electrode active material layer 25 and a negative electrode active material layer 45 of the electrode assembly 2 described later. The Z direction is orthogonal to the X direction and the Y direction.

FIG. 2 is a schematic diagram illustrating a main configuration of the electrode assembly 2. FIG. 3 is a sectional view taken along III-III of FIG. 2. As illustrated in FIG. 3, the electrode assembly 2 has a laminated structure in which a positive electrode current collector 10, the positive electrode active material layer 25, a separator 50, the negative electrode active material layer 45, and a negative electrode current collector 30 overlap in the Z direction.

The positive electrode current collector 10 is, for example, a thin film of aluminum, but may be a thin film of another conductive material.

The positive electrode active material layer 25 is formed by forming a mixture of a plurality of materials (positive electrode materials) employed for formation of a positive electrode in a lithium ion secondary battery into a thin film shape. The positive electrode material includes, for example, a positive electrode active material, a binder, and a conductive material, but can be replaced with any material that may be employed in the past, present, and future in formation of a positive electrode in a lithium ion secondary battery.

The separator 50 is a film-like insulator that insulates the positive electrode active material layer 25 from the negative electrode active material layer 45. The separator 50 has a porous structure that allows permeation of lithium ions.

The negative electrode active material layer 45 is formed by forming a thin film of a mixture of a plurality of materials (negative electrode materials) employed for formation of a negative electrode in a lithium ion secondary battery. The negative electrode material includes, for example, a negative electrode active material, a binder, a conductive material, and a dispersed thickener, but can be replaced with any material that may be employed in the past, present, and future in formation of a negative electrode in a lithium ion secondary battery.

The negative electrode current collector 30 is, for example, thin film-shaped copper, but may be made from another conductive material in a thin film shape.

Except for both ends in the Z direction, one of the positive electrode current collector 10 and two of the positive electrode active material layers 25 sandwiching the one of the positive electrode current collector 10 in the Z direction constitute a positive electrode (cathode) of a lithium ion secondary battery. One of the negative electrode current collector 30 and two of the negative electrode active material layers 45 sandwiching the one of the negative electrode current collector 30 in the Z direction constitute a negative electrode (anode) of a lithium ion secondary battery.

In the electrode assembly 2, a positive electrode and a negative electrode are alternately laminated in the Z direction with the separator 50 interposed between them. Note that both ends in the Z direction of the electrode assembly 2 illustrated in FIGS. 2 and 3 are the positive electrode current collectors 10. The positive electrode current collectors 10 at both ends in the Z direction function as a single-sided positive electrode by being in contact with the positive electrode active material layer 25 only on one side.

The number (number of layers) of the separators 50 included in the electrode assembly 2 is, for example, 20, but is not limited to this, and may be any natural number.

As illustrated in FIG. 2, the current collecting tab 20 extends from one end side in the Y direction of the positive electrode current collector 10. The positive electrode current collector 10 and the current collecting tab 20 are integrated with each other. A position of the current collecting tab 20 extending from each of a plurality of the positive electrode current collectors 10 illustrated in FIG. 3 overlaps one another from a plan viewpoint. The plan viewpoint is a viewpoint in which a plane (X-Y plane) orthogonal to the Z direction is viewed directly.

The current collecting tab 40 extends from one end side in the Y direction of the negative electrode current collector 30. The current collecting tab 40 and the negative electrode current collector 30 are integrated with each other. A position of the current collecting tab 40 extending from each of a plurality of the negative electrode current collectors 30 illustrated in FIG. 3 overlaps one another from the plan viewpoint.

Arrangement of the current collecting tab 20 and arrangement of the current collecting tab 40 are different from each other from the plan viewpoint. The current collecting tab 20 and the current collecting tab 40 are in a separated positional relationship and do not abut on each other.

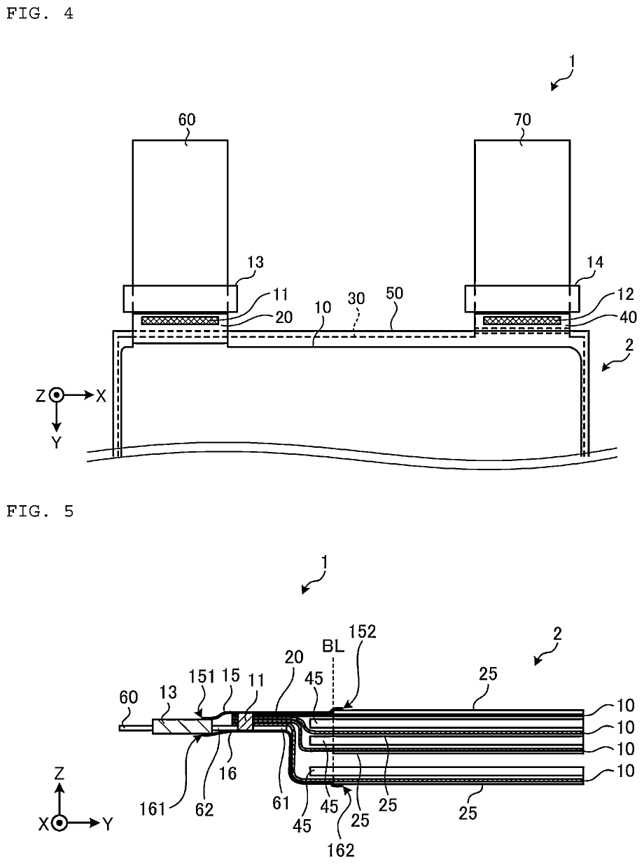

FIG. 4 is a schematic diagram illustrating a configuration around the welded portions 11 and 12 before the tape 15 is attached. As illustrated in FIG. 4, a plurality of the current collecting tabs 20 are welded to the terminal 60 via the welded portion 11. The terminal 60 is an aluminum piece formed in a rectangular shape. As illustrated in FIG. 1, the terminal 60 is provided with a sealant 13 at a position overlapping an end portion of a laminate film 3 from the plan viewpoint.

As illustrated in FIG. 4, a plurality of the negative electrode current collectors 30 are welded to the terminal 70 via the welded portion 12. The terminal 70 is a copper piece or a nickel piece formed in a rectangular shape. As illustrated in FIG. 1, the terminal 70 is provided with a sealant 14 at a position overlapping an end portion of the laminate film 3 from the plan viewpoint.

The sealant 13 and the sealant 14 are adhesive polymer tapes. The sealant 13 functions as a sealing material that covers a part of the terminal 60 by being wound around the terminal 60. The sealant 14 functions as a sealing material that covers a part of the terminal 70 by being wound around the terminal 70. The laminate film 3 is a bag-shaped insulating laminate film including a laminated structure constituted by the positive electrode current collector 10, the positive electrode active material layer 25, the separator 50, the negative electrode active material layer 45, and the negative electrode current collector 30 of the electrode assembly 2 overlapping each other in the Z direction. An opening of a bag of the laminate film 3 is located on the extending direction side of the current collecting tab 20 from the positive electrode current collector 10 and on the extending direction side of the current collecting tab 40 from the negative electrode current collector 30. When the laminate film 3 includes the electrode assembly 2 and is sealed, a bonding portion 31 of the laminate film 3 to be sealed abuts on the sealant 13 and the sealant 14. That is, the terminal 60 and the terminal 70 are provided so as to extend from the laminate film 3 sealed at the bonding portion 31. Note that, in the bonding portion 31, a portion that does not abut on the sealant 13 and the sealant 14 is a portion where the laminate films 3 are bonded to each other. A configuration included in the laminate film 3 is sealed by formation of the bonding portion 31. As described above, the bonding portion 31 functions as a sealing portion of the laminate film 3.

The welded portion 11 is formed by welding the terminal 60 and a plurality of the current collecting tabs 20 further on the electrode assembly 2 side than the sealant 13. The welded portion 12 is formed by welding the terminal 70 and a plurality of the current collecting tabs 40 further on the electrode assembly 2 side than the sealant 14. A formation method of the welded portion 11 and the welded portion 12 is ultrasonic welding, for example, but may be another welding method.

The tape 15 is an insulating tape made from resin. As illustrated in FIG. 1 and FIGS. 5 and 6 to be described later, the tape 15 overlapping the welded portion 11 from the plan viewpoint has a length by which a first edge portion 151 on one end side in the Y direction overlaps the sealant 13 and a second edge portion 152 on another end side in the Y direction overlaps the positive electrode current collector 10. As illustrated in FIG. 1, the tape 15 overlapping the welded portion 11 from the plan viewpoint has a length by which the first edge portion 151 on one end side in the Y direction overlaps the sealant 14 and the second edge portion 152 on another end side in the Y direction overlaps the positive electrode current collector 10.

The first edge portion 151 and the second edge portion 152 have a plurality of irregularities continuously generated in the X direction. Specifically, the first edge portion 151 and the second edge portion 152 illustrated in FIG. 1 have a shape corresponding to a waveform (for example, a triangular wave) with the X direction as an axial direction. For example, in a case of a triangular wave, a plurality of the irregularities referred to here indicate a shape of an outer edge including two or more projecting portions projecting to one side in the Y direction and two or more recessed portions recessed to anther side in the Y direction.

If the tape 15 starts to be peeled off from either one end side in the X direction of the first edge portion 151 or the second edge portion 152, a cut is generated in the tape 15 from a recessed portion of a triangular wave having a shape recessed toward the inner side of the tape 15 before the peeling spreads over the entire tape 15. By the above, if such a start of peeling occurs, only the one end side is separated from most of the tape 15 and peeled off, and a state in which the welded portion 11 or the welded portion 12 is covered by most of the tape 15 can be maintained. As described above, the first edge portion 151 and the second edge portion 152 can prevent the entire tape 15 from peeling off.

Note that the tape 15 is attached to the welded portions 11 and 12 after the welded portions 11 and 12 are formed and before the electrode assembly 2 is packaged with the laminate film 3. The tape 15 does not overlap the bonding portion 31 of the laminate film 3 overlapping the sealant 13 and the sealant 14. That is, in the tape 15, the first edge portion 151 on the terminal 60 side is located on the inner side of the laminate film 3 including the electrode assembly 2.

Width D15 in the X direction of the tape 15 overlapping the welded portion 11 from the plan viewpoint is larger than width D60 in the X direction of the terminal 60 and width in the X direction of the current collecting tab 20. In the example illustrated in FIG. 1, the width D15 in the X direction of the tape 15 overlapping the welded portion 11 from the plan viewpoint corresponds to width in the X direction of the sealant 13.

The width D15 in the X direction of the tape 15 overlapping the welded portion 12 from the plan viewpoint is larger than width D70 in the X direction of the terminal 70 and width in the X direction of the current collecting tab 40. In the example illustrated in FIG. 1, the width D15 in the X direction of the tape 15 overlapping the welded portion 12 from the plan viewpoint corresponds to width in the X direction of the sealant 14.

In the example illustrated in FIG. 1, the tape 15 overlapping the welded portion 11 and the tape 15 overlapping the welded portion 12 have the same width D15 in the X direction, but may have different widths in a case where the width D60 and the width D70 are different from each other.

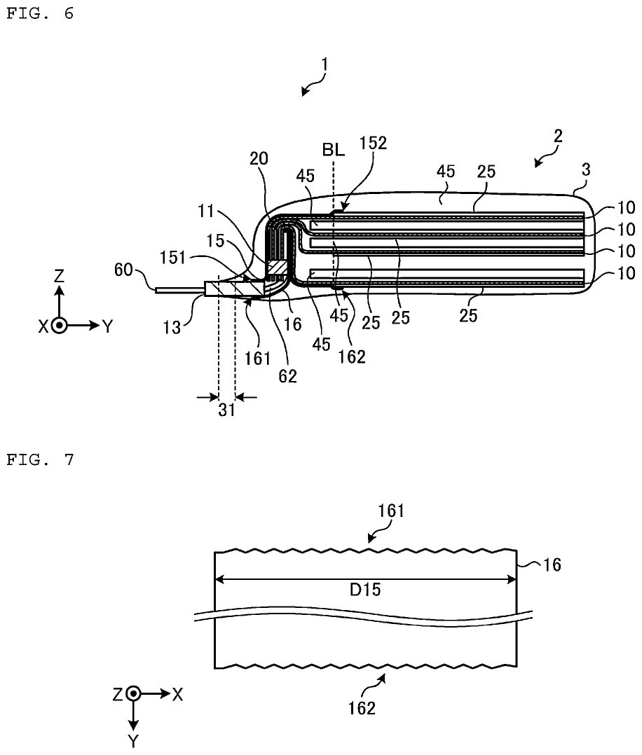

FIG. 5 is a schematic diagram illustrating an example of the secondary battery 1 before being packaged in the laminate film 3. FIG. 6 is a schematic diagram illustrating an example of the secondary battery 1 after being packaged in the laminate film 3. As illustrated in FIGS. 5 and 6, a tape 16 is provided at a position facing the tape 15 in the Z direction with the welded portion 11 interposed between them. Similarly to the tape 15, the tape 16 is an insulating tape made from resin. Note that, in FIGS. 5 and 6, the separator 50 is not illustrated. Further, in FIGS. 5 and 6, a boundary BL in the Y direction between the current collecting tab 20 and the positive electrode current collector 10 is illustrated.

A first edge portion 161 on one end side in the Y direction of the tape 16 illustrated in FIGS. 5 and 6 overlaps the sealant 13 from the plan viewpoint. A second edge portion 162 on another end side in the Y direction of the tape 16 illustrated in FIGS. 5 and 6 is located further on the electrode assembly 2 side than the welded portion 11 and an extending portion 61 from the plan viewpoint and overlaps the positive electrode current collector 10. The extending portion 61 is a portion of the terminal 60, and is a portion extending further to the electrode assembly 2 side than the welded portion 11.

As illustrated in FIG. 6, a deformation allowing portion 62 after the electrode assembly 2 is packaged with the laminate film 3 is curved so as to bring the welded portion 11 closer to the electrode assembly 2. The deformation allowing portion 62 is a portion of the terminal 60 and is a portion located between the welded portion 11 and the sealant 13. The tape 15 and the tape 16 have a length corresponding to a shape of the terminal 60 including the deformation allowing portion 62 curved as illustrated in FIG. 6. That is, the length of the tape 15 and the tape 16 is adjusted such that the first edge portions 151 and 161 and the second edge portions 152 and 162 are located as described above after the curving. Further, as illustrated in FIG. 6, a portion between the first edge portion 151 and the second edge portion 152 of the tape 15 is curved on the inner side of the laminate film 3. Further, a portion between the first edge portion 161 and the second edge portion 162 of the tape 16 is curved on the inner side of the laminate film 3.

Although not illustrated, the tape 16 is also provided at a position facing the tape 15 in the Z direction with the welded portion 12 interposed between them. The first edge portion 161 of the tape 16 at a position facing the tape 15 in the Z direction with the welded portion 12 interposed between them overlaps the sealant 14 from the plan viewpoint. The second edge portion 162 on another end side in the Y direction of the tape 16 extends further to the electrode assembly 2 side than the welded portion 12 and the terminal 70 from the plan viewpoint, reaches the positive electrode current collector 10, and overlaps a portion of the positive electrode current collector 10.

FIG. 7 is a schematic diagram of the tape 16 illustrated in FIG. 5 as viewed from the plan viewpoint. As illustrated in FIG. 7, in the first edge portion 161 and the second edge portion 162, similarly to the first edge portion 151 and the second edge portion 152, a plurality of irregularities are formed continuously generated in the X direction. Specifically, the first edge portion 161 and the second edge portion 162 illustrated in FIG. 1 have a shape corresponding to a triangular wave whose axial direction is the X direction. As described above, the first edge portion 161 and the second edge portion 162 form a plurality of irregularities, so that it is possible to prevent the entire tape 16 from being peeled off.

Further, width in the X direction of the tape 16 is equal to the width D15 in the X direction of the tape 15. That is, the width D15 in the X direction of the tape 16 overlapping the welded portion 11 from the plan viewpoint is larger than the width D60 in the X direction of the terminal 60 and width in the X direction of the current collecting tab 20. Further, the width D15 in the X direction of the tape 16 overlapping the welded portion 12 from the plan viewpoint is larger than width D70 in the X direction of the terminal 70 and width in the X direction of the current collecting tab 40. Further, as illustrated in FIG. 6, the tape 16 does not overlap the bonding portion 31 of the laminate film 3, and the first edge portion 161 on the terminal 60 side is located on the inner side of the laminate film 3 including the electrode assembly 2.

Note that shapes of the first edge portions 151 and 161 and the second edge portion 152 and 162 are not limited to a triangular wave shape, and only need to be a wave shape in which a recessed portion that forms a shape recessed toward the inner side of the tapes 15 and 16 and has an opening angle of less than 180 degrees is generated. For example, the shape may have a sawtooth wave shape with the X direction as the axial direction.

As described above, the secondary battery 1 according to the embodiment includes the electrode assembly 2 in which a plurality of positive electrodes and a plurality of negative electrodes are laminated with the separator 50 interposed between them, a plurality of the current collecting tabs 20 and 40 extending from each current collectors (the positive electrode current collector 10 and the negative electrode current collector 30) of a plurality of positive electrodes and a plurality of negative electrodes, the conductive terminals 60 and 70 joined to a plurality of the current collecting tabs 20 and 40 and provided with the sealants 13 and 14, and the laminate film 3 including the electrode assembly 2. A plurality of the positive electrodes and a plurality of the negative electrodes include a current collector and an active material layer (the positive electrode active material layer 25 and the negative electrode active material layer 45) formed on a surface of the current collector, and the insulating tapes 15 and 16 covering a joint portion between a plurality of the current collecting tabs 20 and the terminals 60 and 70 are included. The laminate film has a sealing portion (bonding portion 31). The tape 15 has the first edge portion 151 at one end on the tip side of a terminal and the second edge portion 152 at another end, the tape 16 has the first edge portion 161 at one end on the tip side of the terminal and the second edge portion 162 at another end, and each of the first edge portions 151 and 161 and the second edge portions 152 and 162 has a plurality of irregularities.

By the above, if the tapes 15 and 16 start to be peeled off from a corner of an outer edge, only a part including a portion where the peeling is started is peeled off by being separated from most of the tapes 15 and 16, and a state in which the welded portion 11 or the welded portion 12 is covered with most of the tapes 15 and 16 can be maintained. As described above, according to the embodiment, it is possible to prevent peeling of the tapes 15 and 16 from spreading over the entire surface. Furthermore, since an outer edge of both ends in the Y direction of the tapes 15 and 16 forms a plurality of irregularities continuously generated in the X direction, if peeling is started from either of both ends, a state in which the welded portion 11 or the welded portion 12 is covered with most of the tapes 15 and 16 can be maintained.

Further, the first edge portions 151 and 161 and the second edge portions 152 and 162 have a waveform. That is, in the first edge portions 151 and 161 and the second edge portion 152 and 162, a plurality of recesses and projections are periodically arranged. By the above, if the tapes 15 and 16 start to be peeled off from a corner of an outer edge, only a part including a portion where the peeling is started is peeled off by being separated from most of the tapes 15 and 16, and a state where a state of covering the welded portion 11 or the welded portion 12 with most of the tapes 15 and 16 can be maintained can be more reliably ensured.

Further, a part of the terminal 60 is covered with a sealing material (the sealant 13), a part of the terminal 70 is covered with a sealing material (the sealant 14), the laminate film 3 has the bonding portion 31 bonded to the sealing material, and the width D15 in the X direction of the tapes 15 and 16 is larger than width in the X direction of the current collecting tabs 20 and 40. By the above, adhesion between the sealants 13 and 14 and the tapes 15 and 16 can be further improved, and occurrence of peeling can be further prevented.

Further, in the tapes 15 and 16, the first edge portions 151 and 161 on the terminals 60 and 70 sides are located on the inner side of the laminate film 3 with respect to a sealing portion (the bonding portion 31). That is, the tapes 15 and 16 are not located in a sealed portion (for example, the bonding portion 31) of the laminate film 3. By the above, sealing property of the laminate film 3 can be more reliably ensured.

Further, the tape 15 is curved between the first edge portion 151 and the second edge portion 152 on the inner side of the laminate film 3. Further, the tape 16 is curved between the first edge portion 161 and the second edge portion 162 on the inner side of the laminate film 3. If the tapes 15 and 16 have such a curved shape and are likely to start to peel off, it is possible to maintain a state in which the welded portion 11 or the welded portion 12 is covered with most of the tapes 15 and 16.

Note that the embodiment described herein is intended to facilitate understanding of the present application, but not intended to construe the present application in any limited way. The present application may be modified or improved without departing from the gist of the present application, and equivalents of the present application are also included in the present application.

### DESCRIPTION OF REFERENCE SYMBOLS

1: Secondary battery
2: Electrode assembly
3: Laminate film
10: Positive electrode current collector
11, 12: Welded portion
13, 14: Sealant
15, 16: Tape
20, 40: Current collecting tab
25: Positive electrode active material layer
31: Bonding portion
30: Negative electrode current collector
45: Negative electrode active material layer
50: Separator
60, 70: Terminal
151, 161: First edge portion
152, 162: Second edge portion

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode assembly in which a plurality of positive electrodes and negative electrodes are laminated with a separator interposed therebetween;
a plurality of current collecting tabs extending from each current collector of the plurality of positive electrodes and negative electrodes;
a conductive terminal joined to the plurality of current collecting tabs; and
a laminate film including the electrode assembly,
wherein the plurality of positive electrodes and negative electrodes have a current collector and an active material layer formed on a surface of the current collector,
the secondary battery further comprising an insulating tape covering a joint portion between the plurality of current collecting tabs and the terminal,
wherein the laminate film has a sealing portion, and
the tape has a first edge portion at one end on a tip side of the terminal and a second edge portion at another end, and each of the first edge portion and the second edge portion has a plurality of irregularities.

2. The secondary battery according to claim 1, wherein the first edge portion and the second edge portion have a waveform.

3. The secondary battery according to claim 1, wherein
a part of the terminal is covered with a sealing material,
the laminate film has a bonding portion bonded to the sealing material, and
width of the tape is larger than width of the current collecting tab in a width direction orthogonal to both a laminating direction of the electrode assembly and an extending direction of the current collecting tab.

4. The secondary battery according to claim 1, wherein the tape has the first edge portion located on an inner side of the laminate film with respect to the sealing portion.

5. The secondary battery according to claim 4, wherein the tape is curved between the first edge portion and the second edge portion on the inner side of the laminate film.
